(19) United States
(12) Patent Application Publication
(10) Pub. No.: US 2022/0203957 A1
(43) Pub. Date: Jun. 30, 2022

(54) MOVING MACHINE CONTROL PROGRAM AND MOVING MACHINE CONTROL DEVICE

(71) Applicant: KAWASAKI MOTORS, LTD., Akashi-shi (JP)

(72) Inventors: Daisuke YANASE, Kobe-shi (JP); Kyotaro NAKAYAMA, Kobe-shi (JP); Daisuke KAWAI, Kobe-shi (JP); Tomoki TADA, Akashi-shi (JP)

(21) Appl. No.: 17/645,090

(22) Filed: Dec. 20, 2021

(30) Foreign Application Priority Data
Dec. 28, 2020 (JP) 2020-218275

(51) Int. Cl. B60W 20/11; B60W 10/06; B60W 10/188; B60W 10/11; B60W 10/08; B60W 20/30

(52) U.S. Cl. CPC B60W 20/11; B60W 10/06; B60W 10/188; B60W 10/11; B60W 10/08; B60W 2050/0017; B60W 2556/10; B60W 2710/0666; B60W 2710/083; B60W 2510/1005; B60W 20/30

(57) ABSTRACT

A moving machine control program causes a computer to execute: acquiring requested external force regarding an actuator; reading out a reference kinetic model that defines moving machine behavior exhibited when the actuator generates external force corresponding to the requested external force; calculating, as requested moving machine behavior, the moving machine behavior exhibited when the actuator generates the external force corresponding to the requested external force, in accordance with the reference kinetic model; measuring actual moving machine behavior during traveling of the moving machine; correcting the requested external force such that the actual moving machine behavior measured in the measuring step approaches the requested moving machine behavior calculated in the calculating step; and controlling the actuator based on the corrected requested external force.

### CROSS-REFERENCE TO RELATED APPLICATION

This application claims priority to and the benefit of Japanese Patent Application No. 2020-218275 filed on Dec. 28, 2020 with the Japan Patent Office, the entire disclosure of which is incorporated herein by reference.

### BACKGROUND OF THE INVENTION

### Field of the Invention

The present disclosure relates to a moving machine control program and a moving machine control device.

### Description of the Related Art

According to engine torque control disclosed in International Publication No. 2014/167983, a relation between a driving condition (for example, a rotational frequency or a load) of a vehicle and engine torque is represented in a map based on experiments, and a command value of a throttle opening degree and a command value of an ignition timing are determined from requested torque (target torque) with reference to the map.

However, according to the conventional torque control, when there is an error in adaptation of the map, or when a situation change or a disturbance which is not considered in the map occurs, actual torque that is actually output deviates from the requested torque. Therefore, the intended actual torque may not be obtained. Moreover, the behavior of the vehicle with respect to the request of a rider may be desired to be controlled in accordance with preference of the rider or the like.

### SUMMARY OF THE INVENTION

A computer-readable storage medium according to one aspect of the present disclosure stores a moving machine control program of a moving machine. The moving machine control program controls at least one actuator that applies external force in a rotational direction to a wheel. The moving machine control program causes a computer to execute: acquiring requested external force regarding the actuator, the requested external force corresponding to rotational force of the wheel, the rotational force being requested during traveling of the moving machine; reading out a reference kinetic model that defines moving machine behavior exhibited when the actuator generates external force corresponding to the requested external force; calculating, as requested moving machine behavior, the moving machine behavior exhibited when the actuator generates the external force corresponding to the requested external force, in accordance with the reference kinetic model; measuring actual moving machine behavior during the traveling of the moving machine; correcting the requested external force such that the actual moving machine behavior measured in the measuring step approaches the requested moving machine behavior calculated in the calculating step; and controlling the actuator based on the corrected requested external force. The storage medium is a non-transitory, tangible medium.

A moving machine control device according to another aspect of the present invention is a moving machine control device of a moving machine. The moving machine control device controls at least one actuator that applies external force in a rotational direction to a wheel. The moving machine control device controls: a request acquiring section that acquires requested external force regarding the actuator, the requested external force corresponding to rotational force of the wheel, the rotational force being requested during traveling of the moving machine; a reference kinetic model read-out section that reads out a reference kinetic model that defines moving machine behavior exhibited when the actuator generates external force corresponding to the requested external force; a requested behavior calculating section that calculates, as requested moving machine behavior, the moving machine behavior exhibited when the actuator generates the external force corresponding to the requested external force, in accordance with the reference kinetic model; an actual behavior acquiring section that acquires actual moving machine behavior measured during the traveling of the moving machine; a correcting section that corrects the requested external force such that the actual moving machine behavior acquired by the actual behavior acquiring section approaches the requested moving machine behavior calculated by the requested behavior calculating section; and a control section that controls the actuator based on the corrected requested external force.

According to the above configurations, since the requested external force is corrected based on a physical quantity that is easy to measure, both the improvement of measurement accuracy and the suppression of cost increase are realized, and the requested moving machine behavior is easily achieved.

### BRIEF DESCRIPTION OF THE DRAWINGS

FIG. 1 is a block diagram of a hybrid vehicle according to an embodiment.

FIG. 2 is a block diagram of a controller of FIG. 1.

FIG. 3 is a block diagram of a requested vehicle speed calculating section of FIG. 2.

FIG. 4 is a block diagram of a torque correcting section of FIG. 2.

FIG. 5 is a flow chart of processing in the controller of FIG. 2.

FIG. 6 is a block diagram for organizing a logic of vehicle speed feedback of traveling requested torque.

FIG. 7A is a graph showing the traveling requested torque applied to an input shaft in simulation of Comparative Example. FIG. 7B is a graph showing a requested vehicle speed and an actual vehicle speed in a result of the simulation of Comparative Example.

FIG. 8A is a graph showing corrected traveling requested torque applied to the input shaft in simulation of Example. FIG. 8B is a graph showing the requested vehicle speed and the actual vehicle speed in a result of the simulation of Example.

### DESCRIPTION OF THE PREFERRED EMBODIMENTS

Hereinafter, an embodiment will be described with reference to the drawings.

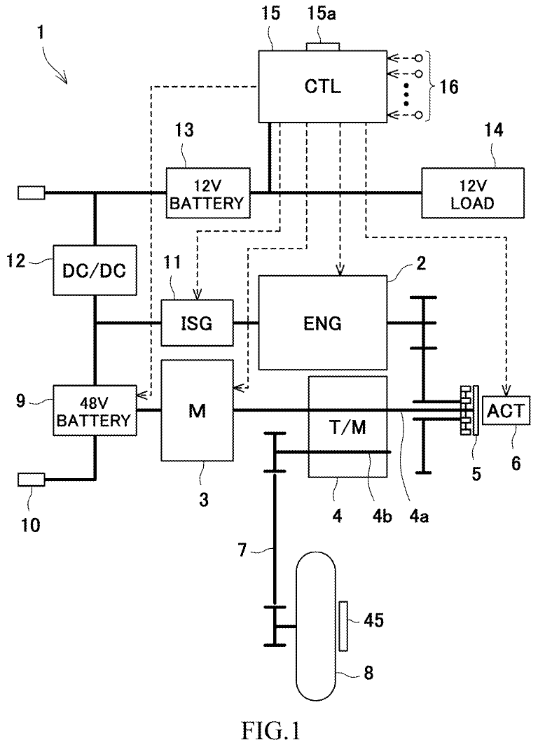

FIG. 1 is a block diagram of a hybrid vehicle 1 according to an embodiment. The hybrid vehicle 1 (moving machine) is, for example, a straddle vehicle (such as a motorcycle or an automatic three-wheeled vehicle) straddled by a rider, but may be an automatic four-wheeled vehicle or the like. As shown in FIG. 1, the hybrid vehicle 1 includes an engine 2 (first prime mover), a drive motor 3 (second prime mover), a transmission 4, a main clutch 5, a clutch actuator 6, an output transmitting structure 7, a driving wheel 8, a first battery 9, a charging port 10, an ISG 11, a converter 12, a second battery 13, an electric component 14 (electric load), and a controller 15.

The engine 2 is an internal combustion engine. The engine 2 is a driving power source that drives the driving wheel 8. The drive motor 3 is an electric motor. The drive motor 3 is a driving power source that drives the driving wheel 8 together with or instead of the engine 2. To be specific, the hybrid vehicle 1 is a parallel hybrid vehicle. The drive motor 3 is an electric motor and also serves as an electric power generator. The transmission 4 changes the speed of rotational power output from the engine 2 and the drive motor 3. The transmission 4 is, for example, a manual transmission including an input shaft 4a, an output shaft 4b, and a speed change gear. The transmission 4 is configured such that a change gear ratio thereof is changed by speed change manipulation of the rider.

The main clutch 5 is interposed on a power transmission path between the engine 2 and the transmission 4. The clutch actuator 6 operates the main clutch 5 such that the main clutch 5 is switched between an engaged state and a disengaged state. For example, when the main clutch 5 is of a hydraulic driving type, the clutch actuator 6 is a solenoid valve that opens or closes a hydraulic passage. The output transmitting structure 7 is a structure through which rotational power output from the output shaft 4b of the transmission 4 is transmitted to the driving wheel 8. The output transmitting structure 7 is, for example, a drive chain, a drive belt, or a drive shaft. The driving wheel 8 is, for example, a rear wheel of the hybrid vehicle 1.

The hybrid vehicle 1 includes: a first transmitting passage (the engine 2, the main clutch 5, the transmission 4, and the output transmitting structure 7) through which torque as external force in a rotational direction is transmitted from the engine 2 through the transmission 4 to the driving wheel 8; and a second transmitting passage (the drive motor 3, the transmission 4, and the output transmitting structure 7) through which torque as external force in the rotational direction is transmitted from the drive motor 3 to the driving wheel 8.

A brake device 45 is disposed at the driving wheel 8. Although not shown in FIG. 1, another brake device is disposed at a front wheel. The brake device 45 applies braking force as external force in the rotational direction to the driving wheel 8. To be specific, each of the engine 2 and the drive motor 3 is an actuator that applies driving force as external force in a positive rotational direction to the driving wheel 8, and the brake device 45 is an actuator that applies braking force as external force in a negative rotational direction to the driving wheel 8.

The first battery 9 stores electric power (for example, 48V) to be supplied to the drive motor 3. The charging port 10 is connected to the first battery 9. The ISG 11 is an integrated starter generator. The ISG 11 can drive the engine 2 at the start of the engine 2 and can be driven by the engine 2 to generate electric power. The converter 12 lowers the voltage of DC power (for example, 48V) supplied from the first battery 9 and the ISG 11 and supplies the power to the second battery 13. The second battery 13 stores electric power (for example, 12V) to be supplied to the controller 15 (moving machine control device) and the electric component 14 mounted on the hybrid vehicle 1. The first battery 9 outputs voltage higher than voltage output from the second battery 13.

The controller 15 controls the engine 2, the drive motor 3, the clutch actuator 6, the ISG 11, and the like based on information detected by a sensor group 16. The controller 15 includes a connector 15a as an interface that is communicable with an outside. The controller 15 may be a single controller or may be constituted by controllers arranged in a distributed manner.

The sensor group 16 includes: a sensor group that detects manipulation of the rider; and a sensor group that detects vehicle states except for the manipulation of the rider. The sensor group 16 includes, for example, an accelerator manipulation amount sensor, a brake manipulation amount sensor, a speed change manipulation sensor, a transmission gear position sensor, a front wheel rotational frequency sensor, a rear wheel rotational frequency sensor, a vehicle body pitch angle sensor, a suspension stroke sensor, a fuel remaining amount sensor, a clutch state sensor, an engine rotational frequency sensor, a motor rotational frequency sensor, a brake state sensor (brake pressure sensor), a gyro sensor, and the like.

The controller 15 determines a driving mode of the hybrid vehicle 1 and controls the engine 2 and the drive motor 3 in accordance with the determined driving mode. In accordance with the manipulation of the rider and the vehicle state (except for the manipulation of the rider), the controller 15 commands a distribution change or switching between the driving of the driving wheel 8 by the engine 2 and the driving of the driving wheel 8 by the drive motor 3.

Examples of the driving mode include an EV mode and an HEV mode. The EV mode is a mode in which: 100% of requested torque is distributed to the drive motor 3; and the traveling is performed by driving the drive motor 3. In the EV mode, the engine 2 is in a stop state or in a state where although the engine 2 is driving, the power generated by the engine 2 is not transmitted to the driving wheel 8. The HEV mode is a mode in which: the requested torque is distributed to the engine 2 and the drive motor 3; and the traveling is performed by driving both the engine 2 and the drive motor 3. In the HEV mode, the clutch actuator 6 is controlled such that the main clutch 5 becomes the engaged state.

The HEV mode may include a state where 100% of the requested torque is distributed to the engine 2. To be specific, the HEV mode is a concept including a mode in which the traveling is performed by driving the engine 2 without driving the drive motor 3. A mode in which: 100% of the requested torque is distributed to the engine 2; and the traveling is performed by driving the engine 2 without driving the drive motor 3 may be referred to as an ENG mode.

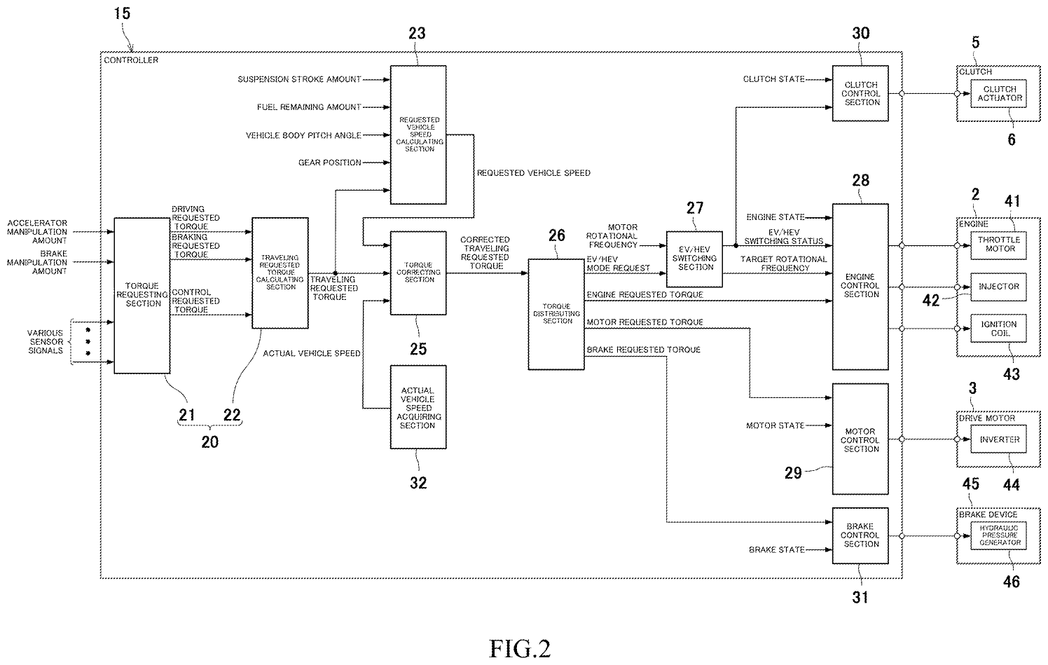

FIG. 2 is a block diagram of the controller 15 of FIG. 1. As shown in FIG. 2, the clutch actuator 6 of the main clutch 5, a throttle motor 41, an injector 42, and an ignition coil 43 of the engine 2, an inverter 44 of the drive motor 3, and a hydraulic pressure generator 46 of the brake device 45 are connected to an output side of the controller 15. The sensor group 16 (see FIG. 1) is connected to an input side of the controller 15.

The controller 15 includes a processor, a memory, an I/O interface, and the like in terms of hardware. The memory includes a storage (for example, a hard disk and a flash memory) and a main memory (RAM). The storage stores a moving machine control program. The storage and the main memory may be collectively called the memory. The moving machine control program includes an instruction which makes the processor output a control command to the main clutch 5 (clutch actuator 6), the engine 2 (the throttle motor 41, the injector 42, or the ignition coil 43), the drive motor 3 (inverter 44), the brake device 45 (hydraulic pressure generator 46), or the like. To be specific, the controller 15 is a kind of computer.

The controller 15 includes a torque requesting section 21, a traveling requested torque calculating section 22, a requested vehicle speed calculating section 23, a reference kinetic model read-out section 24, a torque correcting section 25, a torque distributing section 26, an EV/HEV switching section 27, an engine control section 28, a motor control section 29, a clutch control section 30, a brake control section 31, and an actual vehicle speed acquiring section 32 in terms of function. Each of these sections 21 to 31 is realized in such a manner that the processor performs calculation processing of the moving machine control program read out from the storage by the main memory.

The torque requesting section 21 generates driving requested torque in accordance with an accelerator manipulation amount of the rider, the accelerator manipulation amount being received from the accelerator manipulation amount sensor. The torque requesting section 21 generates braking requested torque in accordance with a brake manipulation amount of the rider, the brake manipulation amount being received from the brake manipulation amount sensor. To be specific, the torque requesting section 21 generates requested torque based on a manipulation amount of a manipulation element manipulated by the rider, the manipulation amount being changeable during traveling of the vehicle. The torque requesting section 21 generates control requested torque for controlling the vehicle, in accordance with various sensor signals received from the sensor group 16.

For example, in accordance with a difference between the rotational frequency of the front wheel received from the front wheel rotational frequency sensor and the rotational frequency of the rear wheel received from the rear wheel rotational frequency sensor, the torque requesting section 21 may generate control requested torque for adjusting driving force of the engine 2 and/or the drive motor 3 and braking force of the front and rear wheels. For example, in accordance with a speed change input received from the speed change manipulation sensor, the torque requesting section 21 may generate control requested torque for adjusting the driving force of the engine 2 and/or the drive motor 3 to reduce gear shift shock.

The traveling requested torque calculating section 22 adds up the driving requested torque, the braking requested torque, and the control requested torque received from the torque requesting section 21 to generate traveling requested torque as torque requested for the input shaft 4a of the transmission 4. The input shaft 4a at which the driving force of the engine 2 and the driving force of the drive motor 3 join is a target part for the traveling requested torque. However, the target part for the traveling requested torque may be another part (for example, an axle of the driving wheel 8) on the power transmission path from the input shaft 4a to the driving wheel 8.

The torque requesting section 21 and the traveling requested torque calculating section 22 serve as a request acquiring section 20 that acquires the traveling requested torque corresponding to the rotational force of the driving wheel 8, the rotational force being requested during the traveling. The request acquiring section 20 may acquire the traveling requested torque (requested external force) based on a manipulation amount of an accelerator manipulation element, a brake manipulation element, or the like manipulated by the rider, the manipulation amount being changeable during the traveling. The request acquiring section 20 may acquire the traveling requested torque (requested external force) based on the vehicle state (the signal of the sensor group 16) except for the manipulation of the rider.

As requested moving machine behavior, the requested vehicle speed calculating section 23 calculates behavior of the hybrid vehicle 1, the behavior being exhibited when the traveling requested torque is generated at the input shaft 4a of the transmission 4. The behavior is a value regarding the movement of the hybrid vehicle 1. The value regarding the movement may be, for example, displacement, speed, or acceleration. In the present embodiment, as a requested vehicle speed, the requested vehicle speed calculating section 23 calculates a vehicle speed (the rotational speed of the driving wheel 8) exhibited when it is assumed that the traveling requested torque is generated at the input shaft 4a of the transmission 4. To be specific, the requested vehicle speed changes in accordance with a change in the traveling requested torque. As a physical quantity indicating the requested moving machine behavior, the requested vehicle speed calculating section 23 may calculate the displacement or the acceleration instead of the vehicle speed.

The actual vehicle speed acquiring section 32 acquires an actual vehicle speed (actual moving machine behavior) measured by the vehicle speed sensor (for example, a wheel speed sensor). The actual vehicle speed acquiring section 32 is, for example, an input interface of the controller 15 which receives the signal of the vehicle speed sensor.

The torque correcting section 25 corrects the traveling requested torque calculated by the traveling requested torque calculating section 22 such that the actual vehicle speed acquired by the actual vehicle speed acquiring section 32 approaches the requested vehicle speed calculated by the requested vehicle speed calculating section 23. Details of the torque correcting section 25 will be described later.

Based on the corrected traveling requested torque output from the torque correcting section 25, the torque distributing section 26 determines an EV/HEV mode request, engine requested torque, motor requested torque, and brake requested torque. Based on the corrected traveling requested torque, the torque distributing section 26 determines whether to set the traveling mode to the EV mode or the HEV mode, in accordance with a predetermined rule. Based on the determined traveling mode and the corrected traveling requested torque, the torque distributing section 26 determines the engine requested torque, the motor requested torque, and the brake requested torque.

When the corrected requested torque is positive torque that accelerates the driving wheel 8, the torque distributing section 26 performs acceleration control of the engine 2 and/or the drive motor 3. When the corrected requested torque is negative torque that decelerates the driving wheel 8, the torque distributing section 26 performs deceleration control of the engine 2 and/or the drive motor 3 and also controls the brake device 45 such that the brake device 45 generates the braking force according to need.

In accordance with the EV/HEV mode request, the engine requested torque, and the motor requested torque determined by the torque distributing section 26 and the rotational frequency (motor rotational frequency) of the drive motor 3, the EV/HEV switching section 27 determines an EV/HEV switching status, corrected engine requested torque, an engine target rotational frequency, and corrected motor requested torque. In accordance with the traveling mode (EV/HEV mode request) determined by the torque distributing section 26, the EV/HEV switching section 27 outputs the EV/HEV switching status regarding switching between the EV mode and the HEV mode to the engine control section 28 and the clutch control section 30.

When switching from the EV mode to the HEV mode, the EV/HEV switching section 27 determines the engine target rotational frequency based on the motor rotational frequency such that the rotational frequency of the driving force transmitted from the engine 2 to the input shaft 4a approaches the rotational frequency of the driving force transmitted from the drive motor 3 to the input shaft 4a.

The clutch control section 30 controls the clutch actuator 6 based on the EV/HEV switching status output from the EV/HEV switching section 27. For example, when switching from the EV mode to the HEV mode occurs, the clutch control section 30 controls the clutch actuator 6 to change the disengaged state of the main clutch 5 to the engaged state.

The engine control section 28 controls the engine 2 (the throttle motor 41, the injector 42, and the ignition coil 43) such that generated torque of the engine 2 approaches the engine requested torque, and the rotational frequency of the engine 2 approaches the engine target rotational frequency. The motor control section 29 controls the drive motor 3 (inverter 44) such that generated torque of the drive motor 3 approaches the motor requested torque. The brake control section 31 controls the brake device 45 (hydraulic pressure generator 46) such that torque generated by the brake device 45 approaches the brake requested torque.

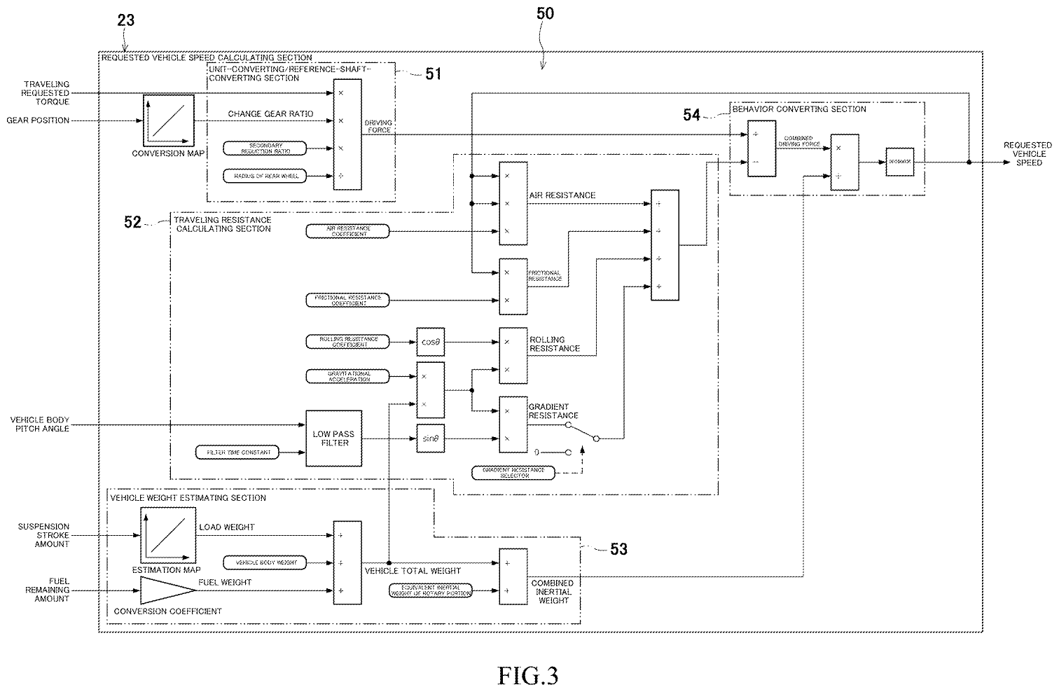

FIG. 3 is a block diagram of the requested vehicle speed calculating section 23 of FIG. 2. The configuration of FIG. 3 is one example, and each element in FIG. 3 may be separated from the other elements and may be arbitrarily omitted or extracted. As shown in FIG. 3, the requested vehicle speed calculating section 23 converts the traveling requested torque into the requested vehicle speed in accordance with a reference kinetic model 50 stored in the storage of the controller 15. The reference kinetic model 50 defines the requested moving machine behavior exhibited when the traveling requested torque is generated by the engine 2, the drive motor 3, and/or the brake device 45.

The reference kinetic model 50 includes parameters that change in accordance with the signals from the sensor group 16. For example, the reference kinetic model 50 changes in accordance with the change gear ratio detected by the transmission gear position sensor, a vehicle body pitch angle detected by the vehicle body pitch angle sensor, a suspension stroke amount detected by the suspension stroke sensor, and a fuel remaining amount detected by the fuel remaining amount sensor.

The requested vehicle speed calculating section 23 includes a unit-converting/reference-shaft-converting section 51, a traveling resistance calculating section 52, a vehicle weight estimating section 53, and a behavior converting section 54. The unit-converting/reference-shaft-converting section 51 converts the traveling requested torque at the target part (input shaft 4a) into the driving force applied from an outer peripheral surface of the driving wheel 8 (rear wheel) to a road surface. In other words, the unit-converting/reference-shaft-converting section 51 calculates vehicle driving force having a positive correlation with the traveling requested torque. Specifically, the unit-converting/reference-shaft-converting section 51 multiplies the traveling requested torque at the input shaft 4a by the change gear ratio calculated from the gear position of the transmission 4 with reference to a predetermined conversion map and a secondary reduction ratio from the transmission 4 to the driving wheel 8 and divides the resultant value by a radius of the driving wheel 8 to calculate the driving force requested for the driving wheel 8. Then, the unit-converting/reference-shaft-converting section 51 outputs the driving force requested for the driving wheel 8.

The traveling resistance calculating section 52 calculates traveling resistance of the hybrid vehicle 1 that travels when torque that is equal to the traveling requested torque is generated at the input shaft 4a. As components of the traveling resistance, the traveling resistance calculating section 52 calculates, for example, air resistance, frictional resistance, rolling resistance, and gradient resistance. Then, the traveling resistance calculating section 52 adds up the air resistance, the frictional resistance, the rolling resistance, and the gradient resistance and outputs the resultant resistance as the traveling resistance.

The air resistance is obtained by multiplying a predetermined air resistance coefficient by the square of the requested vehicle speed calculated by the below-described behavior converting section 54. The frictional resistance is obtained by multiplying a predetermined friction resistance coefficient by the requested vehicle speed calculated by the below-described behavior converting section 54. The rolling resistance is obtained by multiplying a predetermined rolling resistance coefficient by cos θ (θ is a road surface inclination angle) and gravity. The gravity is obtained by multiplying gravitational acceleration by below-described vehicle total weight. The gradient resistance is obtained by filtering the vehicle body pitch angle by a low pass filter of a predetermined filter time constant and then multiplying the resultant value by sin θ (θ is the road surface inclination angle) and gravity. Whether to validate or invalidate the gradient resistance can be selected by a gradient resistance selector. To be specific, whether to include the gradient resistance in the traveling resistance is selectable.

The vehicle weight estimating section 53 estimates entire weight that acts on the motion of the hybrid vehicle 1. In the present embodiment, the vehicle weight estimating section 53 estimates combined inertial weight including not only the vehicle total weight (including load weight) but also equivalent inertial weight of a rotary portion (for example, a flywheel) of the hybrid vehicle 1. However, the vehicle weight estimating section 53 may estimate only the vehicle total weight without considering the equivalent inertial weight of the rotary portion. The vehicle weight estimating section 53 calculates the vehicle total weight (including the weight of the rider) based on predetermined vehicle body weight, the suspension stroke amount detected by the suspension stroke sensor, and the fuel remaining amount detected by the fuel remaining amount sensor.

With reference to an estimation map indicating a relation between the suspension stroke amount and the load weight (the total of the weights of humans and baggage on the vehicle), the vehicle weight estimating section 53 calculates the load weight from the suspension stroke amount. The vehicle weight estimating section 53 prestores the vehicle body weight. The vehicle weight estimating section 53 calculates fuel weight by multiplying a coefficient by the fuel remaining amount (volume), the coefficient indicating a ratio of the fuel weight to fuel volume. The vehicle weight estimating section 53 adds up the load weight, the vehicle body weight, and the fuel weight to obtain the vehicle total weight. Moreover, the vehicle weight estimating section 53 adds the prestored equivalent inertial weight of the rotary portion to the obtained vehicle total weight and outputs the resultant value as the combined inertial weight.

The behavior converting section 54 uses a motion equation to calculate a motion value (displacement, speed, or acceleration) of the driving wheel 8 based on the vehicle driving force calculated by the unit-converting/reference-shaft-converting section 51. Specifically, first, the behavior converting section 54 calculates combined driving force by subtracting the traveling resistance output from the traveling resistance calculating section 52 from the driving force output from the unit-converting/reference-shaft-converting section 51. The behavior converting section 54 calculates vehicle acceleration by subtracting the combined inertial weight output from the vehicle weight estimating section 53 from the combined driving force. To be specific, the behavior converting section 54 utilizes a motion equation to calculate the vehicle acceleration from the combined driving force and the combined inertial weight. The behavior converting section 54 calculates the vehicle speed by integrating the vehicle acceleration and outputs the calculated vehicle speed as the requested vehicle speed corresponding to the traveling requested torque.

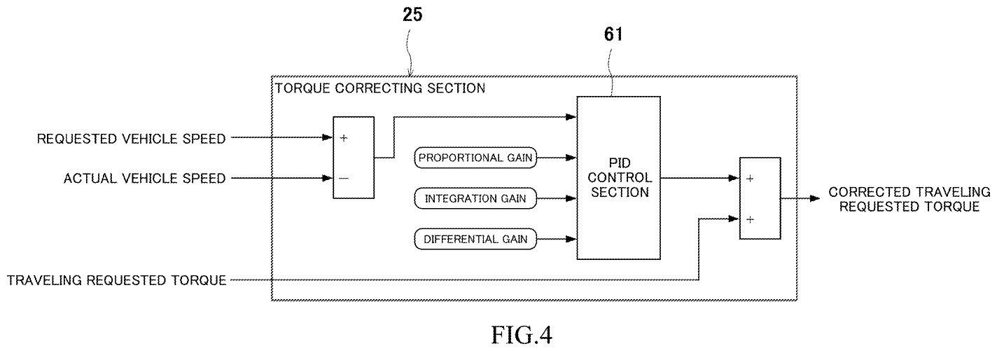

FIG. 4 is a block diagram of the torque correcting section 25 of FIG. 2. As shown in FIG. 4, the torque correcting section 25 performs feedback control of the actual vehicle speed based on a deviation between the requested vehicle speed calculated by the requested vehicle speed calculating section 23 and the actual vehicle speed acquired by the actual vehicle speed acquiring section 32. The torque correcting section 25 includes a PID control section 61 that performs PID control that is a kind of feedback control. The PID control section 61 calculates a correction amount of the traveling requested torque such that the deviation between the requested vehicle speed and the actual vehicle speed becomes small. The PID control is one example, and various feedback control rules may be used. For example, the feedback control may be P control or PI control.

The torque correcting section 25 adds the correction amount to the traveling requested torque calculated by the traveling requested torque calculating section 22 and outputs the resultant value as the corrected traveling requested torque. To be specific, in the feedback control of the torque correcting section 25, the requested vehicle speed input to the torque correcting section 25 is a target value, and the traveling requested torque is a feedforward manipulation amount. Moreover, the corrected traveling requested torque output from the torque correcting section 25 is a manipulation amount, and a difference between the requested vehicle speed and the actual vehicle speed is a deviation (comparison value).

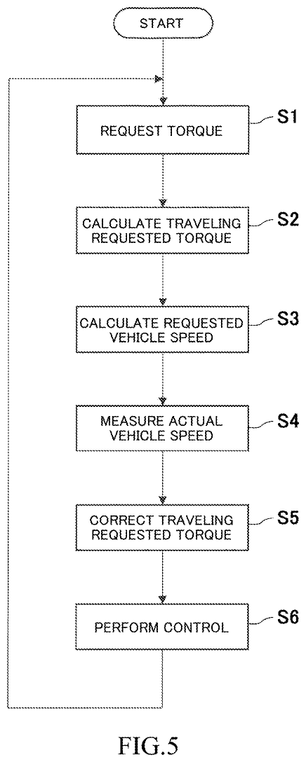

FIG. 5 is a flow chart of processing of the controller 15 of FIG. 2. The following will be described based on the flow chart of FIG. 5 with suitable reference to FIG. 2. The torque requesting section 21 of the controller 15 outputs the driving requested torque, the braking requested torque, and the control requested torque based on the detection signal of the sensor group 16 (Step S1). Based on the respective requested torques output from the torque requesting section 21, the traveling requested torque calculating section 22 calculates the traveling requested torque corresponding to the rotational force of the driving wheel 8, the rotational force being requested during the traveling (Step S2). To be specific, the torque requesting section 21 and the traveling requested torque calculating section 22 constitute the request acquiring section 20 that acquires the traveling requested torque corresponding to the rotational force of the driving wheel 8, the rotational force being requested during the traveling.

The requested vehicle speed calculating section 23 calculates the requested vehicle speed from the traveling requested torque calculated by the traveling requested torque calculating section 22 (Step S3). The actual vehicle speed acquiring section 32 acquires the actual vehicle speed measured by the vehicle speed sensor (Step S4). The torque correcting section 25 corrects the traveling requested torque calculated by the traveling requested torque calculating section 22 such that the deviation between the actual vehicle speed acquired by the actual vehicle speed acquiring section 32 and the requested vehicle speed calculated by the requested vehicle speed calculating section 23 becomes small (Step S5).

The torque distributing section 26, the EV/HEV switching section 27, the engine control section 28, the motor control section 29, the clutch control section 30, and the brake control section 31 control the main clutch 5 (clutch actuator 6), the engine 2 (the throttle motor 41, the injector 42, and the ignition coil 43), the drive motor 3 (inverter 44), and the brake device 45 (hydraulic pressure generator 46) based on the corrected traveling requested torque output from the torque correcting section 25 (Step S6). In this control, when the corrected traveling requested torque is a value that accelerates the driving wheel 8, the engine 2 and/or the drive motor 3 are controlled. Moreover, when the corrected traveling requested torque is a value that decelerates the driving wheel 8, the brake device 45 is controlled in addition to the control of the engine 2 and/or the drive motor 3.

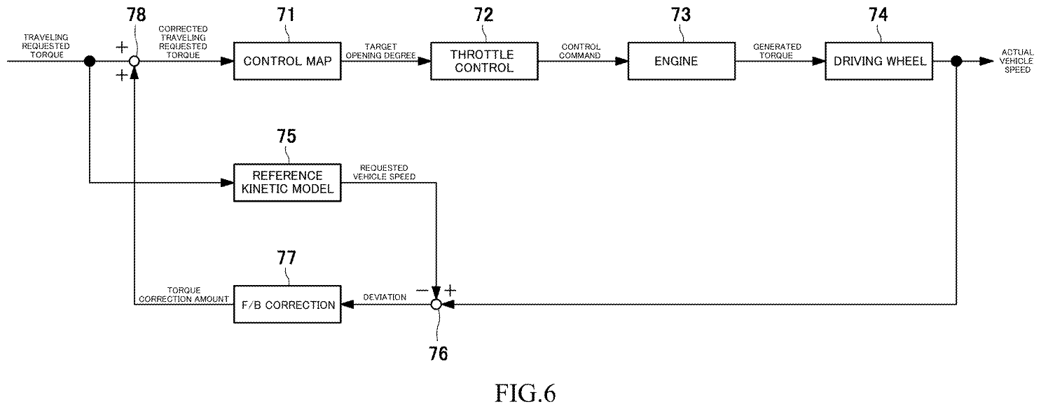

FIG. 6 is a block diagram for organizing a logic of the vehicle speed feedback of the traveling requested torque. The concept of the above-described feedback control will be described based on an example in which the actuator is an engine. As shown in FIG. 6, in a block 71, a target opening degree corresponding to the corrected traveling requested torque obtained by correcting the traveling requested torque is obtained with reference to a control map that defines a relation between the torque and the throttle opening degree. In a block 72, a throttle control command corresponding to the target opening degree is obtained. In a block 73, the throttle valve is driven in accordance with the throttle control command, and the engine generates torque. In a block 74, the vehicle travels by driving the driving wheel in accordance with the generated torque of the engine, and with this, the actual vehicle speed is determined.

In a block 75, the reference kinetic model to which the traveling requested torque is input outputs the requested vehicle speed. A subtracter 76 calculates a deviation between the requested vehicle speed and the actual vehicle speed. A block 77 calculates the torque correction amount by which feedback correction of the traveling requested torque is performed such that the deviation decreases. An adder 78 calculates the above-described corrected traveling requested torque by adding the torque correction amount to the traveling requested torque. The block 75 corresponds to the requested vehicle speed calculating section 23 of FIG. 3. A group of the subtracter 76, the block 77, and the adder 78 corresponds to the torque correcting section 25 of FIG. 4.

The requested vehicle speed calculating section 23 can change the parameters of the reference kinetic model 50 in accordance with an input of a user. Specifically, an information processing apparatus (for example, a personal computer, a smartphone, a vehicle onboard device (such as a vehicle onboard navigation system or a vehicle onboard meter device)) is communicably connected to the communication interface 15a of the controller 15 through wired or wireless communication. With this, the user can change the setting of the requested vehicle speed calculating section 23 by using the information processing apparatus. For example, the air resistance coefficient, the friction resistance coefficient, the gradient resistance selector, the equivalent inertial weight of the rotary portion, and the like in the reference kinetic model 50 can be changed by the input of the user through the communication interface 15a.

For example, when the information processing apparatus connected to the communication interface 15a is the vehicle onboard navigation system, the value of the parameter may be set in accordance with positional information or road surface information (for example, when the road surface is slippery, the value of the parameter is set such that the suppression of fall-down is intended). Moreover, for example, when the information processing apparatus connected to the communication interface 15a is the vehicle onboard meter device or a handle switch, the information processing apparatus and a handle are arranged close to each other, and therefore, operability of the rider improves.

The reference kinetic model 50 may be a model that simulates the actual hybrid vehicle 1 with a high degree of accuracy or may be a model that does not simulate the actual hybrid vehicle 1. For example, the vehicle behavior may be changeable according to preference by setting the vehicle body weight in the reference kinetic model 50 to a value lighter than the actual weight of the hybrid vehicle 1. The parameter that is changeable by the user may be a parameter other than the above. Moreover, instead of the motion equation constituting the reference kinetic model 50, a polynomial equation that does not depend on mechanical interpretation may be used. Furthermore, the parameter in the reference kinetic model 50 may be updated over time based on learning by artificial intelligence.

According to the above-described configuration, the traveling requested torque regarding the engine 2, the drive motor 3 and/or the brake device 45 is converted from force as the physical quantity that is difficult to measure into the vehicle speed that is easy to measure, and the traveling requested torque is corrected such that the actual moving machine behavior approaches the converted requested vehicle speed. Therefore, the requested moving machine behavior is easily achieved. Especially, when the hybrid vehicle 1 is a straddle vehicle or a sport traveling vehicle, the weight of the vehicle is light relative to the generated torque of a prime mover. Therefore, the deviation between the target torque and the generated torque is easily reflected in the motion behavior of the vehicle, and the responsiveness of the vehicle behavior with respect to the request is high. Moreover, influence on the feeling of the rider by a behavior change is large. Thus, the effectiveness of the present configuration is high.

Moreover, since the feedback control of the traveling requested torque is performed based on the deviation between the requested vehicle speed and the actual vehicle speed, the actual vehicle speed can be made to approach the requested vehicle speed with a high degree of accuracy. Furthermore, the output characteristic of the torque control can be prevented from changing by switching between the EV mode and the HEV mode. To be specific, the torque of the drive motor 3 is hardly influenced by disturbance (for example, atmospheric pressure, temperature, or wind speed), but the torque of the engine 2 that is the internal combustion engine is easily influenced by the disturbance.

Therefore, by realizing the feedback control that can suppress the influence of the disturbance, the change in the output characteristic by the mode switching can be prevented. Especially when switching the traveling mode in accordance with the vehicle state other than the manipulation state of the rider (when switching the traveling mode in a case where the rider does not actively perform manipulation), uncomfortable feeling of the rider can be suppressed. Moreover, all the relations between various conditions and the engine torque do not have to be experimentally covered. For example, an engine torque map which considers load changes due to various factors, such as atmospheric pressure, temperature, gradient, and weight change is unnecessary.

Moreover, the physical quantity (vehicle speed) into which the traveling requested torque is converted is a value (such as moving machine displacement, speed, acceleration, wheel rotational frequency, moving machine coordinates, or speed vector) related to the movement of the hybrid vehicle 1. Therefore, a sensor that detects the physical quantity can also be used for other applications. On this account, unlike a case where the torque is detected, special parts, special devices, estimation formulas, and the like are unnecessary. Furthermore, since the traveling requested torque is calculated based on the manipulation amount of the manipulation element manipulated by the rider, the manipulation amount being changeable during the traveling, satisfactory driving feeling can be realized for the rider.

Moreover, since the requested vehicle speed calculating section 23 outputs the requested vehicle speed in accordance with the detection result of the sensor group 16 disposed at the hybrid vehicle 1, the requested vehicle speed calculating section 23 can calculate the requested vehicle speed corresponding to the actual motion behavior. Furthermore, when the traveling requested torque is force that accelerates the driving wheel 8, the engine 2 and/or the drive motor 3 are controlled. When the traveling requested torque is force that decelerates the driving wheel 8, the engine 2 and/or the drive motor 3 are controlled, and the brake device 45 is controlled. Therefore, requested acceleration or requested deceleration can be achieved. Moreover, since the requested vehicle speed calculating section 23 outputs the requested vehicle speed in accordance with the gear position, a requested value in which the user's intention by speed change is reflected can be obtained.

Moreover, since the requested vehicle speed calculating section 23 is configured such that the parameter of the reference kinetic model 50 can be changed in accordance with the input of the user, the requested vehicle speed calculating section 23 can calculate the requested vehicle speed corresponding to the motion behavior intended by the user. To be specific, since the parameter of the reference kinetic model 50 can be adjusted from an outside, the user can easily customize the vehicle characteristics.

Moreover, the driving behavior is prevented from changing due to differences of the characteristics of the respective prime movers when switching the prime movers that transmit power to the driving wheel 8. Thus, feeling variations given to the rider can be suppressed. Specifically, the torque of the electric motor 3 is hardly influenced by the disturbance (for example, atmospheric pressure or temperature), but the torque of the engine 2 that is the internal combustion engine is easily influenced by the disturbance. Therefore, by realizing the feedback control that can suppress the influence of the disturbance, the change in the output characteristic by the switching between the EV mode and the HEV mode can be prevented.

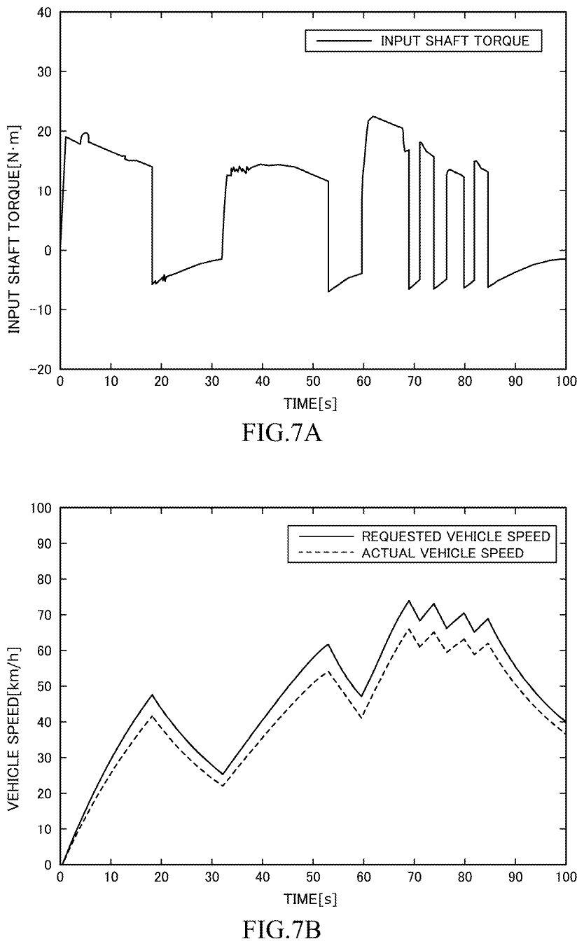

Next, simulation results of Comparative Example and Example will be described. FIG. 7A is a graph showing the traveling requested torque applied to the input shaft in the simulation of Comparative Example. FIG. 7B is a graph showing the requested vehicle speed and the actual vehicle speed in the simulation result of Comparative Example. Comparative Example is an example in which: the requested vehicle speed calculating section 23 and the torque correcting section 25 are omitted from FIG. 2; and the traveling requested torque output from the traveling requested torque calculating section 22 is input to the torque distributing section 26. In Comparative Example, the traveling requested torque (target torque) shown in FIG. 7A is input to the simulation model. As a result, as shown in FIG. 7B, the deviation is generated between the actual vehicle speed and the requested vehicle speed (target vehicle speed) by the influence of the disturbance (the requested vehicle speed of FIG. 7B is obtained by using the reference kinetic model).

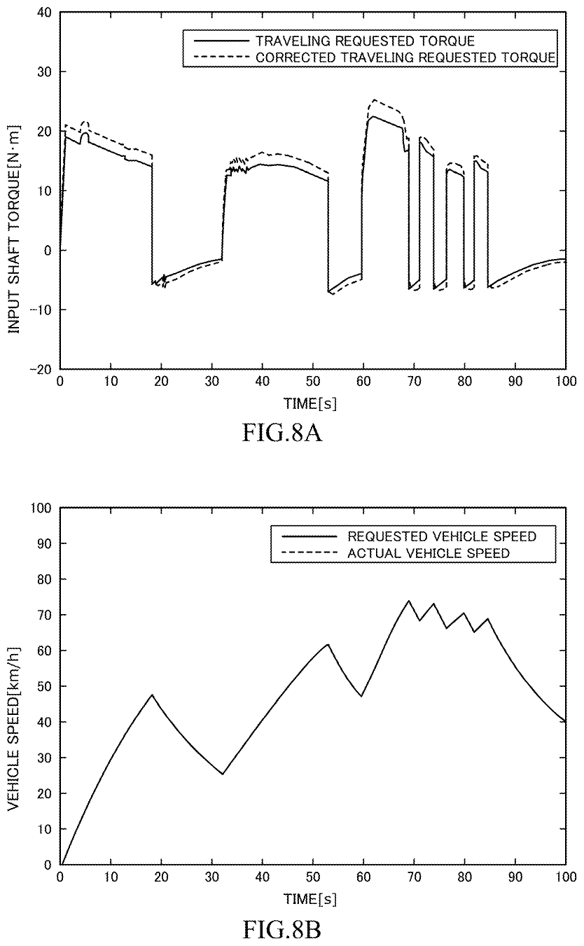

FIG. 8A is a graph showing the corrected traveling requested torque applied to the input shaft in the simulation of Example. FIG. 8B is a graph showing the requested vehicle speed and the actual vehicle speed in the simulation result of Example. The configuration of Example is the same as the configuration of FIG. 2. In Example, the traveling requested torque shown in FIG. 8A is input to the simulation model. With this, the corrected traveling requested torque is obtained by the requested vehicle speed calculating section 23 and the torque correcting section 25. As a result of control based on the corrected traveling requested torque, as shown in FIG. 8B, the actual vehicle speed substantially coincides with the requested vehicle speed (target vehicle speed) (in FIG. 8B, a broken line coincides with a solid line).

The present disclosure is not limited to the above embodiment, and modifications, additions, and eliminations may be made with respect to the configuration of the embodiment. For example, the above technique is applicable to vehicles other than the hybrid vehicles. Specifically, the above technique is applicable to engine vehicles and electric vehicles. The type of the driving power source is not especially limited.

Both the actuator that applies external force (i.e., driving force) in a proceeding direction and the actuator that applies external force (i.e., braking force) in a direction opposite to the proceeding direction do not have to be actuators controlled by algorithm of the controller 15, and only one of these actuators may be an actuator controlled by algorithm of the controller 15. The actuator that applies the braking force is not limited to the brake device and may be at least one of engine braking and regenerative braking. To be specific, the requested torque corrected by the torque correcting section 25 is not limited to acceleration torque and may be deceleration torque.

The requested external force regarding the actuator (such as the engine, the electric motor, or the brake device) may be applied from the rider, may be prestored in the memory of the controller 15, or may be calculated based on information provided from a device outside the vehicle. The requested external force may be determined in accordance with external environment, such as a traveling route or a traffic status. Like automatic driving, the requested external force may be automatically determined without a request from the rider.

The requested external force may be represented by a value other than the torque. In the above embodiment, the torque (unit: newton meter) is described as the requested external force. However, for example, the requested external force may be a different value as long as the value is correlated to the external force applied to the vehicle. For example, the requested external force may be force (unit: newton) applied to the vehicle. In this case, the reference kinetic model 50 is a model that calculates the vehicle speed (requested vehicle speed) at which the requested external force is generated by the vehicle.

When determining the traveling requested torque based on the manipulation of the rider, the traveling requested torque may be corrected in accordance with the clutch manipulation amount so as to be suppressed. Since the traveling requested torque is changed in accordance with the manipulation amount (acceleration, brake, clutch, speed change) input from the rider, control based on the request of the rider is realized. For example, by suppressing the influence of the disturbance of the control corresponding to the accelerator manipulation, the vehicle speed change corresponding to the expectation of the rider can be realized.

In the present embodiment, the influences due to the differences of the responsiveness and output characteristic among the EV mode, the HEV mode, and the ENG mode are suppressed. This is especially effective in a moving machine in which the torque distribution of the HEV mode variously changes during the traveling. When braking (engine braking or regenerative braking) by the prime movers 2 and 3 and mechanical braking (brake device 45) are combined with each other at the time of deceleration, and these braking means and the torque distribution variously change, uncomfortable braking feeling is suppressed.

The reference kinetic model 50 of the present embodiment is one example. When determining the reference kinetic model 50 based on a motion equation, the reference kinetic model 50 may be determined without considering assumed resistance components. The reference kinetic model 50 may be set such that among resistance components (traveling resistance, frictional resistance, rolling resistance, and gradient resistance) shown in FIG. 3 and an acceleration component (gradient acceleration), a component(s) whose influence may be small is omitted. For example, when the gradient resistance is omitted in FIG. 3, the influence of the gradient of the traveling road surface is suppressed, and the moving machine is controlled such that the behavior (for example, the vehicle speed) approaches the requested behavior.

To be specific, the resistance component itself may become one disturbance. By performing such control that the influence of the disturbance is suppressed, driving feeling similar to the driving feeling during the traveling on flat ground may be provided during the traveling on slopes. Moreover, in the reference kinetic model 50, instead of estimating the vehicle weight by the vehicle weight estimating section 53, a predetermined vehicle weight estimated value may be stored in the storage. In this case, a change in weight of the actual moving machine becomes one disturbance. Similarly, even when the reference kinetic model 50 is simplified, and a component itself omitted when simplifying the reference kinetic model 50 becomes the disturbance, the influence of such component can be suppressed.

The reference kinetic model 50 may not be based on the motion equation. For example, the reference kinetic model 50 may be a function or a two-dimensional map in which the requested vehicle speed is set for each value of the traveling requested torque. By suitably selecting the reference kinetic model as above, the moving machine behavior can be changed in accordance with a request, and with this, the driving feeling can be changed.

The reference kinetic model may be changed such that the moving machine behavior becomes behavior corresponding to the request of the user. For example, the reference kinetic model may be set such that output responsiveness with respect to the traveling requested torque becomes high, and this may realize such a feeling that the rider is driving the moving machine equipped with a high-output driving power source. Moreover, the reference kinetic model may be set such that the vehicle weight is light, and this may realize light traveling feeling. Furthermore, the torque characteristic with respect to the rotational frequency may be changed in accordance with the choice of the rider. Plural types of reference kinetic models that imitate behaviors of a sport type, an American type, a moto-cross type, and the like may be prepared, and the traveling feeling corresponding to a situation or preference may be realized in accordance with the choice of the rider.

The functionality of the elements disclosed herein may be implemented using circuitry or processing circuitry which includes general purpose processors, special purpose processors, integrated circuits, ASICs (“Application Specific Integrated Circuits”), conventional circuitry and/or combinations thereof which are configured or programmed to perform the disclosed functionality. Processors are considered processing circuitry or circuitry as they include transistors and other circuitry therein. The processor may be a programmed processor which executes a program stored in a memory. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

What is claimed is:

1. A computer-readable storage medium storing a moving machine control program of a moving machine, the moving machine control program controlling at least one actuator that applies external force in a rotational direction to a wheel,
the moving machine control program causing a computer to execute:
acquiring requested external force regarding the actuator, the requested external force corresponding to rotational force of the wheel, the rotational force being requested during traveling of the moving machine;
reading out a reference kinetic model that defines moving machine behavior exhibited when the actuator generates external force corresponding to the requested external force;
calculating, as requested moving machine behavior, the moving machine behavior exhibited when the actuator generates the external force corresponding to the requested external force, in accordance with the reference kinetic model;
measuring actual moving machine behavior during the traveling of the moving machine;
correcting the requested external force such that the actual moving machine behavior measured in the measuring step approaches the requested moving machine behavior calculated in the calculating step; and
controlling the actuator based on the corrected requested external force.

2. The storage medium according to claim 1, wherein in the correcting step, feedback control of the requested external force is performed based on a deviation between the requested moving machine behavior calculated in the calculating step and the actual moving machine behavior measured in the measuring step.

3. The storage medium according claim 1, wherein the moving machine behavior is a value regarding movement of the moving machine.

4. The storage medium according to claim 1, wherein in the acquiring step, the requested external force is acquired based on a manipulation amount of a manipulation element manipulated by a rider, the manipulation amount being changeable during the traveling of the moving machine.

5. The storage medium according to claim 1, wherein the reference kinetic model outputs the moving machine behavior in accordance with a detection result of a sensor disposed at the moving machine.

6. The storage medium according to claim 1, wherein:
the at least one actuator comprises a prime mover and a brake device; and
in the controlling step,
the prime mover is controlled when the requested external force is force that accelerates the wheel, and
the brake device is controlled when the requested external force is force that decelerates the wheel.

7. The storage medium according to claim 6, wherein:
the moving machine includes a component that applies torque as the external force from the actuator to the wheel through a transmission whose change gear ratio is changed by speed change manipulation of the rider; and
the reference kinetic model outputs the moving machine behavior in accordance with the change gear ratio.

8. The storage medium according to claim 1, wherein:
the at least one actuator comprises a first prime mover and a second prime mover; and
the moving machine comprises a first transmitting passage through which torque is transmitted from the first prime mover to the wheel and a second transmitting passage through which torque is transmitted from the second prime mover to the wheel.

9. The storage medium according to claim 8, wherein the moving machine includes a controller that commands a distribution change or switching between driving of the wheel by the first prime mover and driving of the wheel by the second prime mover in accordance with a state of the moving machine except for the manipulation of the rider.

10. The storage medium according to claim 8, wherein:
the first prime mover is an internal combustion engine; and
the second prime mover is a drive motor.

11. The storage medium according to claim 1, wherein the moving machine is a straddle vehicle.

12. The storage medium according to claim 1, wherein a content of the reference kinetic model is changeable by an input of a user.

13. A moving machine control device of a moving machine,
the moving machine control device controlling at least one actuator that applies external force in a rotational direction to a wheel,
the moving machine control device comprising:
a request acquiring section that acquires requested external force regarding the actuator, the requested external force corresponding to rotational force of the wheel, the rotational force being requested during traveling of the moving machine;
a reference kinetic model read-out section that reads out a reference kinetic model that defines moving machine behavior exhibited when the actuator generates external force corresponding to the requested external force;
a requested behavior calculating section that calculates, as requested moving machine behavior, the moving machine behavior exhibited when the actuator generates the external force corresponding to the requested external force, in accordance with the reference kinetic model;
an actual behavior acquiring section that acquires actual moving machine behavior measured during the traveling of the moving machine;
a correcting section that corrects the requested external force such that the actual moving machine behavior acquired by the actual behavior acquiring section approaches the requested moving machine behavior calculated by the requested behavior calculating section; and
a control section that controls the actuator based on the corrected requested external force.
